(19) United States
(12) Patent Application Publication
(10) Pub. No.: US 2012/0264430 A1
(43) Pub. Date: Oct. 18, 2012

(54) METHOD FOR COMMUNICATION OF BASE STATION, RELAY STATION AND TERMINAL

(75) Inventors: Eunkyung KIM, Daejeon (KR); Sung Kyung Kim, Daejeon (KR); Sung Cheol Chang, Daejeon (KR); Hyun Lee, Daejeon (KR); Chul Sik Yoon, Daejeon (KR); Won-Ik Kim, Daejeon (KR); Mi-Young Yun, Daejeon (KR); Kwang Jae Lim, Daejeon (KR)

(73) Assignee: Electronics and Telecommunications Research Institute, Daejeon (KR)

(21) Appl. No.: 13/440,519

(22) Filed: Apr. 5, 2012

(30) Foreign Application Priority Data
Apr. 5, 2011 (KR) 10-2011-0031327
May 9, 2011 (KR) 10-2011-0043656
Jul. 11, 2011 (KR) 10-2011-0068539
Jul. 12, 2011 (KR) 10-2011-0068730
Jul. 20, 2011 (KR) 10-2011-0071918
Apr. 4, 2012 (KR) 10-2012-0034991
Apr. 4, 2012 (KR) 10-2012-0034992

(51) Int. Cl. H04W 36/00; H04W 88/00

(52) U.S. Cl. 455/436; 455/561

(57) ABSTRACT

The present invention relates to a communication method of a base station, which includes the base station including an indication of whether the base station is a terminal acting as a base station or a base station acting as a relay station in an SCD message or DCD message, and transmitting the SCD message or the DCD message to a terminal.

### CROSS-REFERENCE TO RELATED APPLICATION

This application claims priority to and the benefit of Korean Patent Application Nos. 10-2011-0031327, 10-2011-0043656, 10-2011-0068539, 10-2011-0068730, 10-2011-0071918, 10-2012-0034991, and 10-2012-0034992 filed in the Korean Intellectual Property Office on Apr. 5, 2011, May 9, 2011, Jul. 11, 2011, Jul. 12 2011, Jul. 20, 2011, Apr. 4, 2012, and Apr. 4, 2012, respectively, the entire contents of which are incorporated herein by reference.

### BACKGROUND OF THE INVENTION

(a) Field of the Invention

The present invention relates to a communication method of a base station, a communication method of a relay station, and a communication method of a terminal.

(b) Description of the Related Art

Disasters may destroy or damage important infrastructure. The important Infrastructure includes various communication facilities such as for wireless telephones, wired telephones, the internet, etc. Destruction or damage to these communication facilities may increase society congestion and make recovery of infrastructure difficult. In this case, it is important to provide high reliability support such as means for rapidly recovering or replacing the communication facilities. For high reliability support, a mobile communication system (HR-Network) needs to satisfy the following requirements.

First of all, backward compatibility with existing systems, that is, Wireless MAN-OFDMA or Wireless MAN-Advanced Interface systems, must be satisfied. Then, a base station (HR-base station, HR-BS), a terminal (HR-mobile station, HR-MS) and a relay station (HR-relay station, HR-RS) need to perform a multi-mode operation of functioning as other stations.

Furthermore, communication should be continued even when a base station, a relay station, or a wireless link is unavailable, that is, when a single point of failure (SPOF) is generated. In addition, direct communication between different terminals must be performed. Multicast transmission, that is, enhanced multicast communication, should be available in a network, and path setup including multi-path management for data transmission/reception and path management for managing forwarding should also be available. However, conventional technologies have only requirements, and thus a method for supporting multiple paths is needed.

Particularly, path reestablishment is required when a relay station or base station cannot properly perform the function thereof. If two or more paths are established, it is possible to overcome re-routing delay through an alternative path. However, when the alternative path is set up, a network load may be generated and it is necessary to support continuous establishment, maintenance, and change of the alternative path.

When a base station provides a service through multi-carrier or multi-frequency, if a certain carrier or frequency is not available for the service or service quality is deteriorated, it is necessary to overcome service quality deterioration through an alternative path.

Moreover, establishment of various paths may be performed when a backhaul link is cut off and a base station operates in multiple modes between base stations, between the base station and a relay station, or between relays stations.

### SUMMARY OF THE INVENTION

The present invention has been made in an effort to provide a method for communication of a base station, a relay station, and a terminal to continue providing a communication service through a neighbor base station or a neighbor relay station when a base station or relay station cannot perform the function thereof due to damage to a backhaul link of the base station in a communication system.

The present invention provides a communication method by which a base station providing a service using multi-carrier or multi-frequency continues providing the service using another carrier or frequency. An exemplary embodiment of the present invention provides a communication method of a base station, including: the base station including an indication of whether the base station is a terminal acting as a base station or a base station acting as a relay station in a system configuration descriptor (SCD) message or a downlink channel descriptor (DCD) message; and the base station transmitting the SCD message or the DCD message to a terminal.

Another exemplary embodiment of the present invention provides a communication method of a relay station, including: the relay station including an indication of whether the relay station is a terminal acting as a relay station in an SCD message or a DCD message; and the relay station transmitting the SCD message or the DCD message to a terminal.

Another exemplary embodiment of the present invention provides a communication method of a base station, including: the base station including an indication of whether the base station is a multi-mode apparatus in a neighbor advertisement (NBR-ADV) message; and the base station transmitting the NBR-ADV message to a terminal.

The indication may include an indication of whether the base station is a terminal acting as a base station or a base station acting as a relay station.

Another exemplary embodiment of the present invention provides a communication method of a relay station, including: the relay station including an indication of whether the relay station is a multi-mode apparatus in an NBR-ADV message; and the relay station transmitting the NBR-ADV message to a terminal.

The indication may include an indication of whether the relay station is a terminal acting as a relay station.

Another exemplary embodiment of the present invention provides a communication method of a base station, including: a first base station currently providing a service to a terminal including information about the terminal in a handover message (AAI-HO-CMD); and the first base station transmitting the handover message to a second base station.

The second base station may not share the information about the terminal.

Another exemplary embodiment of the present invention provides a communication method of a base station, including: a first base station terminal providing a service to a terminal designating a first path including the first base station as an active path; and the first base station designating one or more paths including one or more second base stations in a neighborhood of the first base station as an alternative path.

The first path may be changed to an alternative path, and one of the one or more second paths may be changed to an active path when a backhaul link of the first base station is cut off.

Another exemplary embodiment of the present invention provides a communication method of a base station, including: a first base station transmitting information about a terminal provided with a service from the first base station to a neighbor second base station; and the first base station transmitting, to the terminal, information representing that the information has been transmitted to the second base station.

The information may include context information.

The transmitting of the information to the terminal may include the first base station transmitting a list of a plurality of second base stations to the terminal.

The list of a plurality of second base stations may be aligned according to priority.

The transmitting of the information to the terminal may include the first base station transmitting priority of the plurality of second base stations to the terminal.

Another exemplary embodiment of the present invention provides a communication method of a terminal, including: the terminal relaying a first base station providing a service to the terminal and a second base station in a neighborhood of the first base station when a relay link establishment between the first base station and the second base station is unavailable; and managing a first path including the first base station and a second path including the second base station as an alternative path or an active path.

Another exemplary embodiment of the present invention provides a communication method of a terminal using multiple carriers, including: receiving carrier state information from a base station; and the terminal changing a carrier according to the carrier state information.

Another exemplary embodiment of the present invention provides a communication method of a terminal using multiple frequencies, including: receiving frequency state information from a base station; and the terminal performing inter-frequency handover (inter-FA HO) according to the frequency state information.

### BRIEF DESCRIPTION OF THE DRAWINGS

FIG. 1 shows a communication state according to an exemplary embodiment of the present invention;

FIG. 2 shows an example of establishment of a relay link by a base station in case of backhaul damage according to an exemplary embodiment of the present invention;

FIG. 3 shows an example of handover performed by a terminal in case of backhaul damage according to another exemplary embodiment of the present invention;

FIG. 4 shows an example of path reestablishment according to another exemplary embodiment of the present invention;

FIG. 5 shows an example of path reestablishment according to another exemplary embodiment of the present invention;

FIG. 6 shows an example of path reestablishment according to another exemplary embodiment of the present invention;

FIG. 7 shows a relay method of a terminal when relay link establishment is unavailable according to another exemplary embodiment of the present invention;

FIG. 8 shows an example of path establishment through carrier change in case of backhaul damage according to another exemplary embodiment of the present invention; and

FIG. 9 shows an example of path establishment through frequency change in case of backhaul damage according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the overall specification, a mobile station (MS) may refer to a terminal, a mobile terminal (MT), a subscriber station (SS), a portable subscriber station (PSS), an access terminal (AT), user equipment (UE), an advanced mobile station (AMS), a high reliability mobile station (HR-MS), etc., and may include all or some of functions of the terminal, MT, SS, PSS, AT, UE, AMS, HR-MS, etc.

A base station (BS) may refer to a node B, an evolved node B (eNodeB), an access point (AP), a radio access station (RAS), a base transceiver station, (BTS), a mobile multihop relay (MMR)-BS, an advanced base station (ABS), a high reliability base station (HR-BS), a relay station (RS) or an advanced relay station (ARS) that functions as a base station, a high reliability relay station (HR-RS) that functions as a base station, etc., and may include all or some of functions of the node B, eNodeB, AP, RAS, BTS, MMR-BS, ABS, HR-BS, RS, ARS, HR-RS, etc.

A relay method of a base station will be described in detail with reference to the attached drawings.

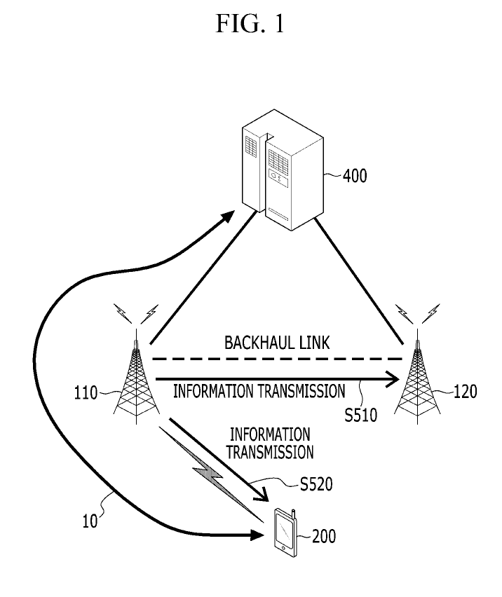

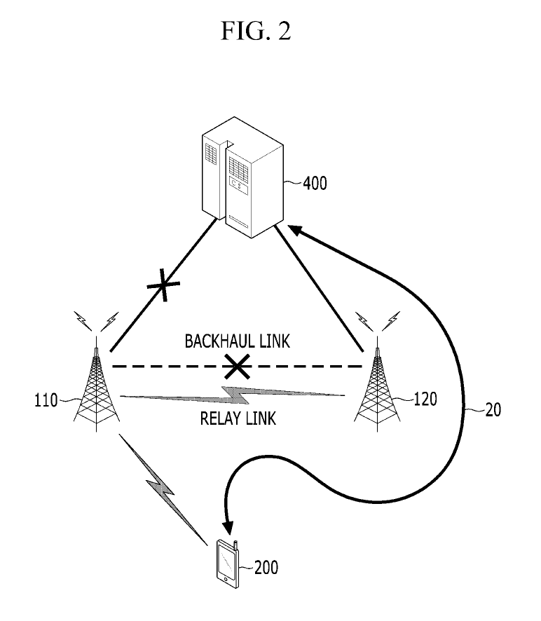

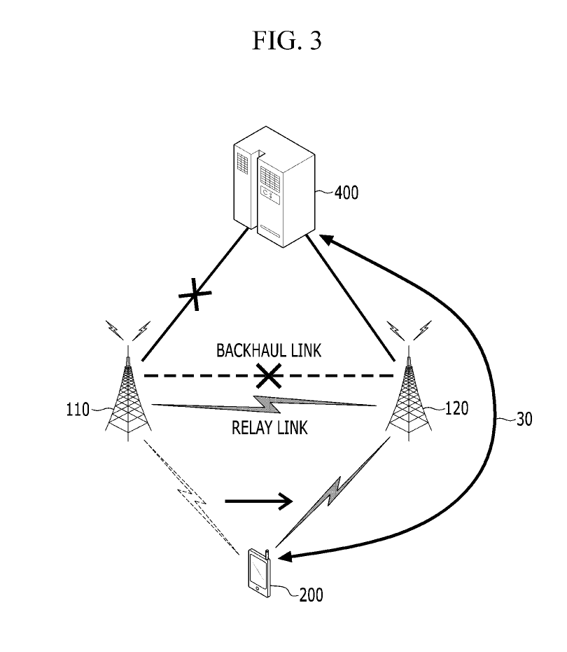

FIG. 1 shows a communication state according to an exemplary embodiment of the present invention, FIG. 2 shows an example of relay link establishment by a base station in case of backhaul damage according to an exemplary embodiment of the present invention, and FIG. 3 shows an example of handover performed by a terminal in case of backhaul damage according to another exemplary embodiment of the present invention.

Referring to FIG. 1, a general communication system includes a server 400 that manages base stations 110 and 120, and a terminal 200 that transmits/receives data to/from the base station 110. A backhaul link is connected between the base stations 110 and 120 as well as among the base stations 110, 120 and the server 400. The terminal 200 and the base station 110 are connected to each other wirelessly. The terminal 200 can be provided with a wireless service or may report data through the base station 110. The base station 110 can transmit data reported by the terminal 200 to the server 400 or another communication apparatus through a predefined path 10.

If the backhaul link of the base station 110 is destroyed, as shown in FIG. 2, the base station 110 can function as a relay station by establishing a relay link between the base station 110 and the base station 120. Then, a path 20 including the base station 120 is reestablished between the terminal 200 and the server 400, and thus the service can be continuously provided between the terminal 200 and the server 400.

Here, the terminal 200 is not provided with the service from the server 400 until the mode of the base station 110 is changed to a relay station, that is, until the relay link is established between the base station 110 and the base station 120,

Even after the establishment of the relay link between the base station 110 and the base station 120, delay may be generated on the path between the base station 110 and the server 400 due to path reestablishment between the base station 120 and the server 400. To prevent this delay, it is necessary to share the path 10 that does not include the base station 120 and the path 20 that includes the base station 120 through the backhaul link between the base station 110 and the base station 120 for the path between the base station 110 and the server 400 in the general communication state, as shown in FIG. 1. Then, the base station 120 can rapidly reestablish the path in the situation as shown in FIG. 2.

To achieve this, the base station 110 transmits information to the base station 120, as shown in FIG. 1 (S510). The information corresponds to information about the terminal 200 to/from which the base station 110 transmits/receives data, and may include context information including server information for data transmission/reception, a context ID, data information at the time of backhaul link cutoff, and information about data to be resumed. The information is periodically transmitted when the backhaul link is unavailable or right before the backhaul link is unavailable. Accordingly, when the path between the base station 110 and the server 400 is unavailable, the path between the base station 120 and the server 400 can minimize delay using the path 20 between the base station 120 and the server 400, which is previously set up and managed, if the relay link is set up between the base station 110 and the base station 120.

FIG. 3 shows an exemplary communication state in which the terminal 200 performs a handover to the base station 120 due to unavailability of the backhaul link of the base station 110 so as to resume transmission/reception of data to/from the server 400. When the base station 110 establishes the relay link between the base station 110 and the base station 120, the base station 110 can transmit information to the base station 120 (S510). In this case, the information includes the ID of the terminal 200, a data context ID, and context information at the time of data transmission/reception interruption and resumption. The terminal 200 performs handover to the base station 120, and the base station 120 can reestablish a path 30 on the basis of the previously set path 20 or information received from the base station 110. Alternatively, the terminal 200 can transmit context information to the base station 120 during the handover procedure (S520), and the base station 120 can reestablish the path on the basis of the previously set path or the received information.

In order for the terminal 200 to efficiently change the path through the base station 110 to the path through the base station 120, the base station 110 can inform the terminal 200 that the base station 110 and the base station 120 share the context information of the terminal 200 even when the backhaul link is not unavailable (S530). In this case, the base station 110 can inform the terminal 200 of a list of neighbor base stations that share the context information of the terminal 200 and transmit information on priority of the neighbor base stations. Accordingly, when the terminal 200 attempts to select a new path, the terminal 200 can select a neighbor base station on the basis of the received list or priority and handover to the selected neighbor base station. The base station 110 and the base station 120 can share the context information of the terminal 200 even after a relay link is established after the backhaul link is unavailable.

That is, a base station or a relay station for which a relay link is set up can establish a path for performing a handover on conditions different from conditions of general base stations or relay stations after the relay link is established. For example, if the neighbor base station 120 has better channel quality than that of the current base station 110, the terminal performs handover to the neighbor base station 120, in general. However, the communication system according to an exemplary embodiment of the present invention can allow a handover to a neighbor base station only when the neighbor base station has channel quality that exceeds a predetermined standard even if the channel quality of the neighbor base station is better than the current base station 110.

Furthermore, the base station or relay station for which the relay link is established does not permit a terminal to enter the base station or relay station (for example, using a cell bar bit in IEEE 802.16m communication system), and when services are not smoothly provided due to interference of a specific terminal, allows the terminal to enter the base station or relay station such that connection between the terminal and a previous base station or relay station can be cut off.

Moreover, in a communication in which a corresponding base station or relay station can operate in multiple modes, distinguished from the general base stations or relay stations, a base station or relay station having a damaged backhaul link or a terminal capable of operating in multiple modes can be restricted from entering a corresponding cell. To achieve this, the above-mentioned other conditions can be given, or a lower terminal can be informed of the fact that the corresponding cell is a cell having a damaged backhaul link or serviced by a multi-mode terminal. In this case, a specific preamble can be used, or information shown in the following Table 1, 2, or 3 can be included in SFH in an IEEE 802.16m system or in a downlink channel descriptor (DCD) or system configuration descriptor (SCD) in IEEE 802.16-2009.

Table 1 shows an exemplary indication of whether the current base station or relay station is a base station or relay station operating in a multi-mode environment or degraded network, which is included in an SCD or DCD message.

TABLE 1

| | | | |
|---|---|---|---|
| | Size | | |
| Field | (bits) | Value/Description | Condition |

| | | |
|---|---|---|
| HR | 1 | Indicates whether current BS/RS is |
| Multi- | | HR-MS acting as BS/RS or HR-BS acting |
| mode | | as RS |
| indication | | 0b0: current BS/RS is neither HR-MS |
| | | acting as BS/RS nor HR-BS acting as RS |
| | | 0b1: current BS/RS is either HR-MS |
| | | acting as BS/RS or HR-BS acting as RS |

In Table 1, the field is a 1-bit HR multi-mode indication, and indicates whether the current base station or relay station is a terminal acting as a base station or relay station or a base station acting as a relay station.

Table 2 shows another exemplary indication of whether the current base station or relay station is a base station or relay station operating in a multi-mode environment or degraded network, which is included in an SCD or DCD message.

TABLE 2

| | | | |
|---|---|---|---|
| | Size | | |
| Field | (bits) | Value/Description | Condition |

| | | |
|---|---|---|
| HR | 2 | Indicates whether current BR/RS is |
| Multi- | | HR-MS acting as BS/RS or HR-BS acting |
| mode | | as RS |
| indication | | 0b00: current BS/RS is neither HR-MS |
| | | acting as BS/RS nor HR-BS acting as RS |
| | | 0b01: current BS/RS is HR-MS acting as |
| | | BS/RS |
| | | 0b10: current BS/RS is HR-BS acting as |
| | | RS |
| | | 0b11: reserved |

Table 3 shows another exemplary indication of whether the current base station or relay station is a base station or relay station operating in a multi-mode environment or degraded network, which is included in an SCD or DCD message.

TABLE 3

| | | | |
|---|---|---|---|
| | Size | | |
| Field | (bits) | Value/Description | Condition |

| | | |
|---|---|---|
| HR | 2 | Indicates whether current BR/RS is |
| Multi- | | HR-MS acting as BS/RS or HR-BS acting |
| mode | | as RS |
| indication | | 0b00: current BS/RS is neither HR-MS |
| | | acting as BS/RS nor HR-BS acting as RS |
| | | 0b01: current BS is HR-MS acting as BS |
| | | 0b10: current RS is HR-MS acting as RS |
| | | 0b11: current BS/RS is HR-BS acting as |
| | | RS |

Alternatively, when path setup or handover is performed for a corresponding base station or a neighbor base station, information indicating whether the neighbor base station is a normal base station or relay station to which a backhaul link is connected or a base station or relay station acting in multiple modes or having a relay link established therefore can be included in a neighbor advertisement (NBR-ADV) message and transmitted to a corresponding terminal such that the terminal can perform a handover in consideration of the information.

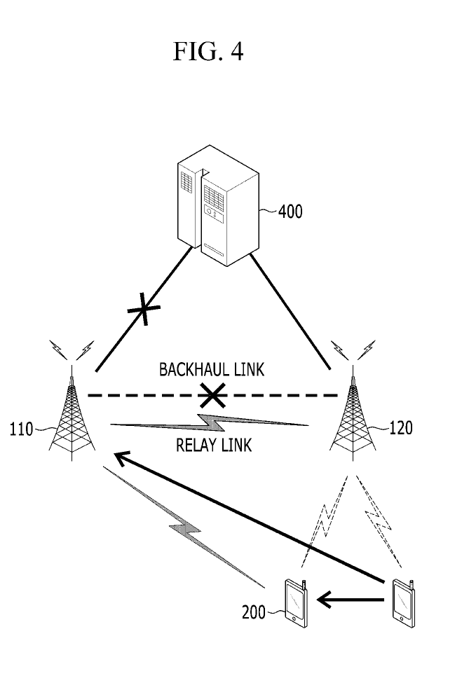

A method for establishing an optimized path in a multi-mode environment will be described in detail with reference to FIG. 4.

FIG. 4 illustrates an example of path reestablishment according to another exemplary embodiment of the present invention, which shows a case in which a relay link is set up between the current base station 110 and the neighbor base station 120 because the backhaul link is unavailable and thus the neighbor base station 120 provides a service. There is a case in which a neighbor base station or relay station is a multi-mode terminal that functions as the base station or relay station.

The current base station 110 can include information about a base station, a relay station, or a multi-mode terminal, which operate in the above-mentioned environment, in an NBR-ADV message, and transmit the NBR-ADV message including the information. That is, the current base station 110 can include the information as shown in Table 1, 2, or 3, or information which represents that the base station or relay station is a base station or relay station acting in multiple modes or degraded network, in the NBR-ADV, and transmits the NBR-ADV.

In general, to perform a handover to a neighbor base station or relay station, a terminal needs to periodically or aperiodically scan the channel state of the neighbor base station. In this case, the terminal reports the scanned channel state of the neighbor base station to a base station or relay station to which the terminal is currently connected. According to an exemplary embodiment of the present invention, it is possible to differently define conditions in which information is reported in consideration of the special situation of the degraded network for the base station, relay station, and multi-mode terminal, as shown in Table 1, 2, or 3, and inform the neighbor base station of the conditions. The conditions can be included in an NBR-ADV message or SCD or DCD message information. The base station notified of the conditions recognizes that the corresponding base station or relay station is a base station or relay station to which the current terminal can handover, and transmits information about the terminal to the base station or relay station through a relay link such that the terminal can perform a handover rapidly and efficiently.

Table 4 shows an exemplary indication of whether a neighbor base station or relay station is a base station or relay station acting in a multi-mode environment or a degraded network, which is included in an NBR-ADV message.

TABLE 4

| | | | |
|---|---|---|---|
| | Size | | |
| Field | (bits) | Value/Description | Condition |

| | | |
|---|---|---|
| HR | 1 | Indicates whether neighbor BR/RS is |
| Multi- | | HR-MS acting as BS/RS or HR-BS acting |
| mode | | as RS |
| indication | | 0b0: neighbor BS is neither HR-MS acting |
| | | as BS/RS nor HR-BS acting as RS |
| | | 0b1: neighbor BS is either HR-MS acting |
| | | as BS/RS or HR-BS acting as RS |

Table 5 shows another exemplary indication of whether a neighbor base station or relay station is a base station or relay station acting in a multi-mode environment or a degraded network, which is included in an NBR-ADV message.

TABLE 5

| | | | |
|---|---|---|---|
| | Size | | |
| Field | (bits) | Value/Description | Condition |

| | | |
|---|---|---|
| HR | 2 | Indicates whether neighbor BR/RS is |
| Multi- | | HR-MS acting as BS/RS or HR-BS acting |
| mode | | as RS |
| indication | | 0b00: neighbor BS is neither HR-MS |
| | | acting as BS/RS nor HR-BS acting as RS |
| | | 0b01: neighbor BS is HR-MS acting as |
| | | BS/RS |
| | | 0b10: neighbor BS is HR-BS acting as RS |
| | | 0b11: reserved |

Table 6 shows another exemplary indication of whether a neighbor base station or relay station is a base station or relay station acting in a multi-mode environment or a degraded network, which is included in an NBR-ADV message.

TABLE 6

| | | | |
|---|---|---|---|
| | Size | | |
| Field | (bits) | Value/Description | Condition |

| | | |
|---|---|---|
| HR | 2 | Indicates whether neighbor BR/RS is |
| Multi- | | HR-MS acting as BS/RS or HR-BS acting |
| mode | | as RS |
| indication | | 0b00: neighbor BS is neither HR-MS |
| | | acting as BS/RS nor HR-BS acting as RS |
| | | 0b01: neighbor BS is HR-MS acting as BS |
| | | 0b10: neighbor RS is HR-MS acting as RS |
| | | 0b10: neighbor BS is HR-BS acting as RS |
| | | 0b11: reserved |

If base stations do not share the information about the terminal when the terminal performs handover, the current base station transmits the information about the terminal to an apparatus to which the terminal can perform handover, such as a base station or relay station, such that the terminal can perform handover to the apparatus. In this case, the current base station can transmit a handover message including the information as shown in Table 4 to the base station, relay station, or multi-mode terminal requested by the terminal for a handover such that the requested base station, relay station, or multi-mode terminal shares the information about the terminal so as to resume the handover after a predetermined time. The information about the terminal can be transmitted to the neighbor base station through the backhaul link if the neighbor base station is connected to the backhaul link. In a multi-mode environment, however, the information about the terminal is transmitted through a relay link connected between apparatuses since a network is constructed through a radio link between the apparatuses. An AAI-L2-XFER message used to transmit control information of an upper layer can be employed to deliver the information about the terminal.

Table 7 shows a handover message (AAI-HO-CMD).

TABLE 7

| | Size | | |
|---|---|---|---|
| Field | (bits) | Value/Description | Condition |
| Mode | 2 | 0b00: HO command; | N/A |
| | | 0b01: Zone switch command | |
| | | from MZone to LZone; | |
| | | 0b10: AMS HO request rejected (ABS in | |
| | | list unavailable). In this case, | |
| | | AAI-HO-CMD message shall not include | |
| | | any T-ABS. However, if the requested | |
| | | ABSs in list is available but MAC | |
| | | information is not shared, those ABSs | |
| | | may be included candidate T-ABS and | |
| | | serving ABS transfers MS information via | |
| | | backbone network or relay link. | |
| | | 0b11: Reserved | |
| If (Mode == | | | |
| 0b00) { | | | |
| . . . | . . . | . . . | . . . |
| }else if (Mode | | | |
| == 0b01) { | | | |
| . . . | . . . | . . . | . . . |
| }else if | | | |
| (Mode==0b10) | | | |
| { | | | |
| REQ-Duration | 8 | The 8 least significant bits of the absolute | |
| | | superframe number where the AMS may | |
| | | perform handover again (i.e., allowing | |
| | | the AMS to transmit AAI-HO-REQ after | |
| | | REQ-Duration). | |
| for (i=0; i < | | N_Target_BS is the number of T-ABSs | |
| N_Target_BS; | | or target legacy BSs included in this | |
| i++) { | | message. | |
| targetBSID | 48 | BSID of the T-ABS or target legacy BS. | Shall be included |
| SA-Preamble | 10 | Indicates the SA-Preamble index of the | Shall be included if |
| Index | | carrier. | the BS is T-ABS |
| Preamble Index | 7 | Indicates the preamble index of the | Shall be included if |
| | | neighbor BS. | the BS is target |
| | | | legacy BS |
| Center | 32 | Indicates center frequency (in unit of Hz) | Shall be included |
| Frequency | | of the carrier. | |
| } | | | |
| } | | | |

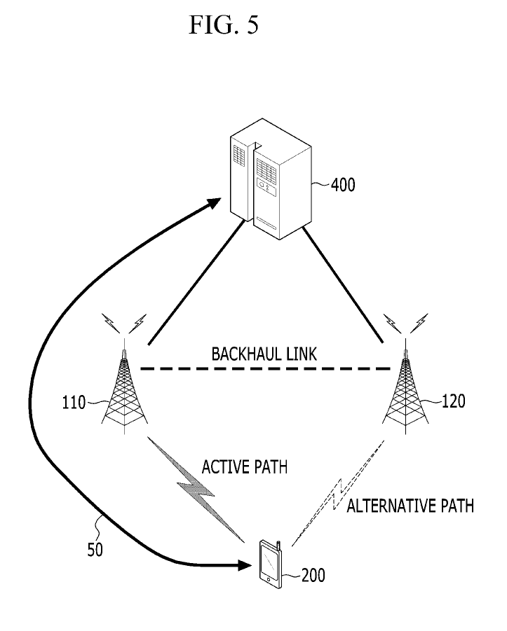

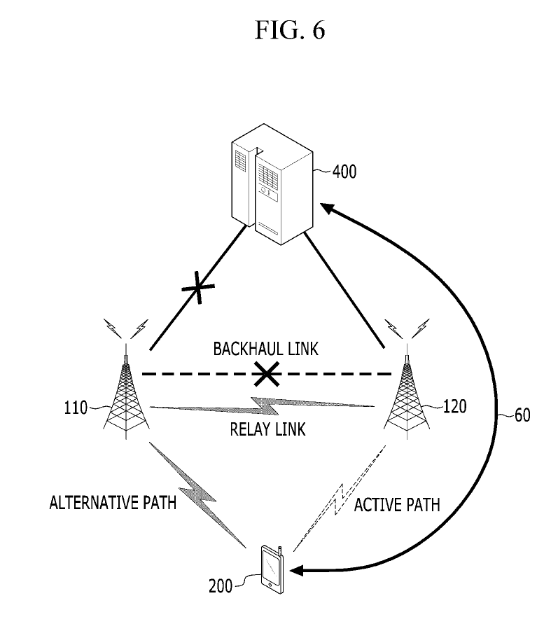

A method for establishing an optimized path in a multi-mode environment according to another exemplary embodiment will be described in detail with reference to FIGS. 5 and 6.

FIG. 5 shows an example of path reestablishment according to another exemplary embodiment of the present invention, and FIG. 6 shows another example of path reestablishment according to another exemplary embodiment of the present invention.

Referring to FIG. 5, the base station 110 and the base station 120 share the information about the terminal 200 and the terminal 200 transmits/receives data through the base station 110. FIG. 6 shows a case in which the base station 110 and the base station 120 acting as a relay station share the information about the terminal 200, and the terminal 200 transmits/receives data through the base station 110.

In the case of FIG. 5, the service is provided to the terminal 200 through the base station 110 while the base station 120 maintains connection information, and the path between the base station 110 and the terminal 200 corresponds to an active path. Accordingly, data can be transmitted through the base station 120 that shares the information about the terminal 200 without an additional operation when the service cannot be provided through the base station 110, or as necessary.

However, when the base station 110 establishes a relay link with the base station 120 due to cutoff of the backhaul link to provide the service to the terminal 200, as shown in FIG. 6, provision of the service to the terminal 200 by the base station 110 may be restricted compared to the case of FIG. 5. In this case, the service can be provided to the terminal 200 through the base station 120 because the base station 110 and the base station 120 share the information about the terminal 200 as described above. That is, the path connected between the base station 110 and the terminal 200 corresponds to an active path, and the path connected between the base station 120 and the terminal 200 is designated as an alternative path or backup path and managed in the case of FIG. 5, whereas the path connected between the base station 110 and the terminal 200 is changed to an alternative path or backup path and the path connected between the base station 120 and the terminal 200 is changed to an active path to continuously provide the service in the case of FIG. 6. However, path reestablishment can be performed even in the case of FIG. 5 irrespective of the cause of path reestablishment such as backhaul link damage.

The above-mentioned multi-path establishment method can also be applied to a case of recovery of the destroyed backhaul link. While one alternative path or backup back is illustrated in FIGS. 5 and 6, one or more alternative paths or backup paths can be available, and a path selected from the one or more alternative paths or backup paths can become an active path and a previous active path can be changed to an alternative path or backup path. That is, a most reliable path from among a plurality of alternative paths or backup paths can be set as an active path, and reliability can be determined based on various conditions. For example, the reliability can be determined in consideration of a load of an upper apparatus that provides a service to the terminal in addition to presence or absence of the backhaul link.

The above description can be applied to a base station operating in multiple modes. Furthermore, the present embodiment can be applied to a case in which a relay station instead of the terminal 200 communicates with an upper base station or upper relay station through a relay link.

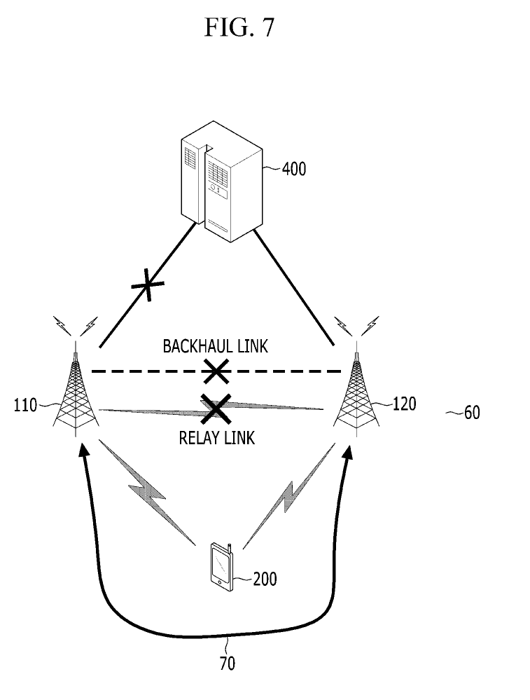

A case in which a relay link cannot be set up between base stations will be described in detail with reference to FIG. 7.

FIG. 7 shows a relay method of a terminal when a relay link cannot be set up according to another exemplary embodiment of the present invention.

As shown in FIG. 7, the terminal 200 can relay data between the base station 110 and the base station 120 when the base station 110 and the base station 120 have difficulty in setting up or a relay link cannot be established. In this case, a connection path between an upper base station, that is, the base station 110 or the base station 120 and the terminal 200 is present, and thus the service can be provided through the connection path. Here, an alternative path or backup path and an active path can be periodically changed. The terminal 200 can function as a relay station to provide the service to a lower terminal or simply perform the function of the terminal to relay data between the base station 110 and the base station 120.

The above description can be applied when the base stations 110 and 120 operate in multiple modes. The present embodiment can be applied to a case in which a relay station instead of the terminal 200 communicates with a base station or relay station through a relay link.

While FIG. 7 shows the base stations 110 and 120, the base stations 110 and 120 can be replaced by two neighbor relay stations in all the figures and description of the specification.

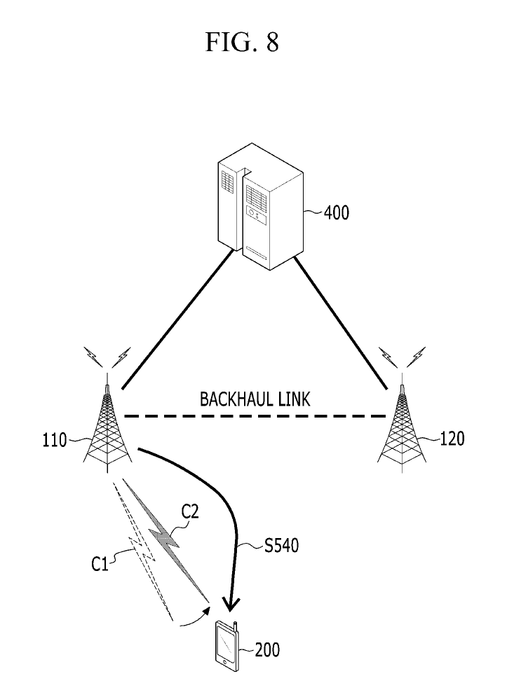

A multi-path establishment method of a base station in a multi-carrier environment will be described in detail with reference to FIG. 8.

FIG. 8 shows an example of path establishment through carrier change in case of backhaul damage according to another exemplary embodiment of the present invention.

Referring to FIG. 8, one carrier operates as a primary carrier and the other carriers operate as secondary carriers according to capability of the terminal 200 when the base station 110 and the terminal 200 communicate with each other using multiple carriers. If a specific carrier is unavailable or service quality is deteriorated, the terminal 200 needs to change the currently serviced carrier to a carrier having better service quality than the currently serviced carrier.

To achieve this, the base station 110 transmits state information of the carrier to the terminal 200 when estimating that the carrier is unavailable or service quality is deteriorated (S540). The state information may include the cause of service quality deterioration, cause of unavailability, service resumption estimation time, or unavailable time. For this, the base station 110 needs to store serviced path information of the terminal 200 in the base station 110 and manage the information.

Upon reception of the state information of the carrier, the terminal 200 can recognize the state of the carrier and change the serviced carrier. To efficiently perform this operation, the terminal 200 can periodically measure a channel state by scanning states of carriers other than the currently serviced carrier. In addition, the terminal 200 can change the currently serviced carrier to a carrier with better quality through the measured channel state.

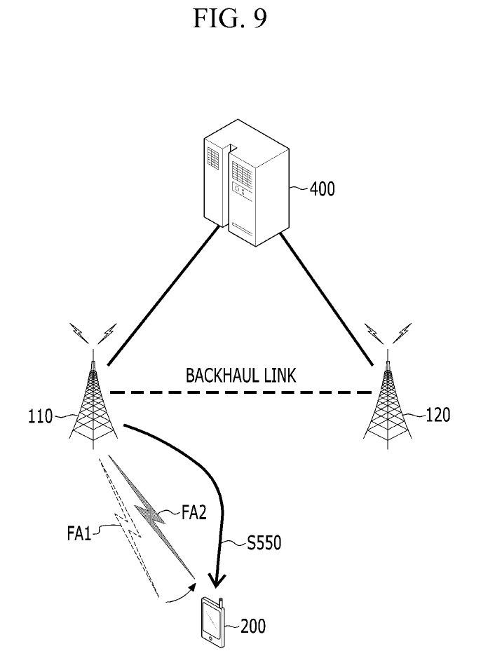

A multi-path establishment method of a base station in a multi-path environment will be described in detail with reference to FIG. 9.

FIG. 9 shows an example of path establishment through frequency change in case of backhaul damage according to another exemplary embodiment of the present invention.

FIG. 9 shows a case in which the base station 110 sets up an optimized path from among multiple paths through frequency change, that is, inter-frequency handover (inter-FA HO), when the base station 110 provides the service using multiple frequencies. As shown in FIG. 8, when a specific frequency cannot provide a service or service quality is deteriorated, the base station 110 transmits information about this state to the terminal 200 (S550). This state information may include the cause of quality deterioration, cause of unavailability, service resumption estimation time, or unavailable time.

Then, the terminal 200 changes the frequency, that is, performs inter-frequency handover, as in the case of FIG. 8. While the inter-frequency handover can be performed at the request of the base station 110, the terminal 200 may perform the inter-frequency handover by measuring the channel state for each frequency. Here, the base station 110 stores and manages service path information of the terminal 200 irrespective of frequency so as to achieve efficient and optimized path change.

When a base station or relay station cannot perform the function thereof in a communication system since a backhaul link of the base station is damaged, a path through which a communication service is continuously provided through a neighbor base station or relay station can be established without delay.

Furthermore, when a base station that provides a service using multiple carriers or multiple frequencies does not satisfy carrier or frequency service, the base station can continue providing the service using other carriers or frequencies.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method of a base station, comprising:
the base station including an indication of whether the base station is a terminal acting as a base station or a base station acting as a relay station in a system configuration descriptor (SCD) message or a downlink channel descriptor (DCD) message; and
the base station transmitting the SCD message or the DCD message to a terminal.

2. A communication method of a relay station, comprising:
the relay station including an indication of whether the relay station is a terminal acting as a relay station in an SCD message or a DCD message; and
the relay station transmitting the SCD message or the DCD message to a terminal.

3. A communication method of a base station, comprising:
the base station including an indication of whether the base station is a multi-mode apparatus in a neighbor advertisement (NBR-ADV) message; and
the base station transmitting the NBR-ADV message to a terminal.

4. The communication method of claim 3, wherein the indication includes an indication of whether the base station is a terminal acting as a base station or a base station acting as a relay station.

5. A communication method of a relay station, comprising:
the relay station including an indication of whether the relay station is a multi-mode apparatus in an NBR-ADV message; and
the relay station transmitting the NBR-ADV message to a terminal.

6. The communication method of claim 5, wherein the indication includes an indication of whether the relay station is a terminal acting as a relay station.

7. A communication method of a base station, comprising:
a first base station currently providing a service to a terminal including information about the terminal in a handover message (AAI-HO-CMD); and
the first base station transmitting the handover message to a second base station.

8. The communication method of claim 7, wherein the second base station does not share the information about the terminal.

11. A communication method of a base station, comprising:
a first base station terminal providing a service to a terminal designating a first path including the first base station as an active path; and
the first base station designating one or more paths including one or more second base stations in a neighborhood of the first base station as an alternative path.

12. The communication method of claim 11, wherein the first path is changed to an alternative path, and one of the one or more second paths is changed to an active path when a backhaul link of the first base station is cut off.

13. A communication method of a base station, comprising:
a first base station transmitting information about a terminal provided with a service from the first base station to a neighbor second base station; and
the first base station transmitting, to the terminal, information representing that the information has been transmitted to the second base station.

14. The communication method of claim 13, wherein the information includes context information.

15. The communication method of claim 13, wherein the transmitting of the information to the terminal comprises the first base station transmitting a list of a plurality of second base stations to the terminal.

16. The communication method of claim 13, wherein the list of a plurality of second base stations is aligned according to priority.

17. The communication method of claim 13, wherein the transmitting of the information to the terminal comprises the first base station transmitting priority of second base stations to the terminal.

18. A communication method of a terminal, comprising:
the terminal relaying a first base station providing a service to the terminal and a second base station in a neighborhood of the first base station when a relay link establishment between the first base station and the second base station is unavailable; and
managing a first path including the first base station and a second path including the second base station as an alternative path or an active path.

19. A communication method of a terminal using multiple carriers, comprising:
receiving carrier state information from a base station; and
the terminal changing a carrier according to the carrier state information.

20. A communication method of a terminal using multiple frequencies, comprising:
receiving frequency state information from a base station; and
the terminal performing inter-frequency handover (inter-FA HO) according to the frequency state information.
